(19) United States
(12) Patent Application Publication
(10) Pub. No.: US 2026/0227721 A1
(43) Pub. Date: Aug. 6, 2026

(54) OPTICAL SCANNING DEVICE AND IMAGE FORMING APPARATUS

(71) Applicants: Susumu NARITA, Kanagawa (JP); Masaaki YOSHIKAWA, Kanagawa (JP); Yoshinobu SAKAUE, Kanagawa (JP); Yuji KATO, Kanagawa (JP)

(72) Inventors: Susumu NARITA, Kanagawa (JP); Masaaki YOSHIKAWA, Kanagawa (JP); Yoshinobu SAKAUE, Kanagawa (JP); Yuji KATO, Kanagawa (JP)

(21) Appl. No.: 19/149,856

(22) PCT Filed: Mar. 22, 2023
(86) PCT No.: PCT/IB2023/052792

§ 371 Date: Jul. 22, 2025

(30) Foreign Application Priority Data
Mar. 16, 2023 (JP) 2023-041839

(51) Int. Cl. G03G 15/01; B41J 2/447; B41J 2/47

(52) U.S. Cl. CPC G03G 15/011; B41J 2/447; B41J 2/471; G03G 15/0189

(57) ABSTRACT

An optical scanning device includes a resin component formed by injection molding, and an electronic component and an optical component disposed to maintain a prescribed position and posture in the resin component. In the optical scanning device, at least one of the electronic component and the optical component that are used for an optically-writing scanning system serves as a heat-generating component that generates heat as power to be applied to operation is supplied, and a weld line position that occurs when the resin component is molded is kept away from a prescribed range around a heated portion of the resin component affected by the heat liberated by the electronic component.

### TECHNICAL FIELD

Embodiments of the present disclosure relate to an optical scanning device and an image forming apparatus.

### BACKGROUND ART

In the related art, scanning devices have been proposed each of which is provided with a pair of deflective devices that distribute and deflect the light beams emitted from a plurality of light sources in two different directions and a plurality of optical elements that form images of the deflected and scanned light beams on corresponding photoconductors that serve as the to-be-scanned objects. Moreover, in the related art, image forming apparatuses have been proposed that adopt an electrophotographic method and form an image by light beams using any known scanning device.

In such image forming apparatuses that adopt electrophotography, as part of the measures to reduce the environmental load, a recycled material such as a recycled resin material may be used as a material used for manufacturing a component that holds internally-provided optical components or electronic components in certain arrangements. However, such a recycled resin material tends to have variability in the quality of the original recycled material, and the fluidity of the molten resin of the recycled material is uneven compared with new material when molded using injection molding. For those reasons, it is known in the art that the use of recycled resin material tends to cause defect in molding.

For the purpose of reducing the defect in molding when the recycled resin material is used, some technologies have been proposed to foam and inject gas in the procedure of molding using recycled resin material. As such technologies, some methods called, for example, fine foam molding and supercritical foam molding are known in the art.

Moreover, as an application of, for example, the above fine foam molding, technologies are known in the art to reduce a confluent portion of a molten resin forms a linear trace, which may be referred to as a weld line, in the injection molding using a die or mold (see, for example, PTL 1).

### CITATION LIST

### Patent Literature

[PTL 1]

Japanese Unexamined Patent Application Publication No. 2008-221481

### SUMMARY OF INVENTION

### Technical Problem

Currently, efforts are being made to promote Sustainable Development Goals (SDGs) (see the 2030 Agenda for Sustainable Development, a set of international development goals, which was adopted by the UN Sustainable Development Summit held on Sep. 25, 2015). One of the goals is “responsible consumption and production” and there are increasing demands for encouraging the recycling or reuse of resources.

As in the technologies known in the art, an attempt to produce a new resin-molded product using a recycled resin material may meet the current demands (see, for example, PTL 1). However, even if the weld line is prevented by using the technologies disclosed in PTL 1, there is a technical problem in terms of measures against heat.

For example, even if the technologies known in the art as in PTL 1 is used, a merging portion of the molten resin is made without exception during resin molding, and such a merging portion could turn to a weld line. Such a portion that could turn to a weld line tends to have a lower density of resin than the other portions. Accordingly, a merging portion of the molten resin that could turn to a weld line tends to have a lower heat resistance than the other portions. When a portion with reduced heat resistance is positioned near a heat-generating component that tends to generate heat among all the components or the like arranged inside the apparatus, for example, the shape of a component made of resin may deform due to the heat liberated by the heat-generating component. In particular, a portion with reduced heat resistance is positioned near a high-heat-generating component that tends to reach high temperature, for example, the shape of a component made of resin tends to deform due to the heat liberated by the heat-generating component. As a result, for example, the strength of a resin molding component may deteriorate, or the alignment with the components around may become defective.

Accordingly, even if the technologies known in the art are applied, there is a technical problem in reducing the influence of the heat liberated from a heat-generating portion and the influence of heat on an area around the portion heated by the heat-generating portion, for the portions where the heat resistance is lowered in the components or elements used inside the apparatus using a resin molded product.

### Solution to Problem

A scanning device includes a resin component formed by injection molding, and an electronic component and an optical component disposed to maintain a prescribed position and posture in the resin component. In the scanning device, at least one of the electronic component and the optical component that are used for an optically-writing scanning system serves as a heat-generating component that generates heat as the power to be applied to operation is supplied, and a weld line position that occurs when the resin component is molded is kept away from a prescribed range around a heated portion of the resin component affected by the heat liberated by the electronic component.

### Advantageous Effects of Invention

According to one aspect of the present disclosure, the influence of heat can be reduced in the optical scanners that use components manufactured using foam molding technologies.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a schematic diagram illustrating a configuration of an image forming apparatus according to an embodiment of the present disclosure.

FIG. 2 is a schematic sectional view of an optical scanning device according to an embodiment of the present disclosure that serves as a scanning device, and illustrates its configuration or structure.

FIG. 3 is a schematic plan view and top view of the optical scanning device of FIG. 2 and illustrates a configuration or structure of its scanning optical system, according to an embodiment of the present disclosure.

FIG. 4 is a schematic plan view of the optical scanning device of FIG. 2 and illustrates a configuration or structure of its scanning optical system, according to an embodiment of the present disclosure.

FIG. 5 is a diagram illustrating the position of a weld line caused by injection molding, according to an embodiment of the present disclosure.

FIG. 6 is a diagram illustrating how the heat is transferred from a heat source and the relation between the heat source and an area affected by the heat liberated from the heat source, according to an embodiment of the present disclosure.

FIG. 7 is another diagram illustrating how the heat is transferred from a heat source and the relation between the heat source and an area affected by the heat liberated from the heat source, according to an embodiment of the present disclosure.

FIG. 8 is a diagram illustrating the relation between a heat source and a portion affected by the heat generated by the heat source, according to an embodiment of the present disclosure.

FIG. 9 is a sectional view of a resin component used for an optical scanning device, according to an embodiment of the present disclosure.

### DESCRIPTION OF EMBODIMENTS

### Embodiment of Image Forming Apparatus

Firstly, an image forming apparatus provided with a scanning device according to an embodiment of the present disclosure is described below with reference to the drawings.

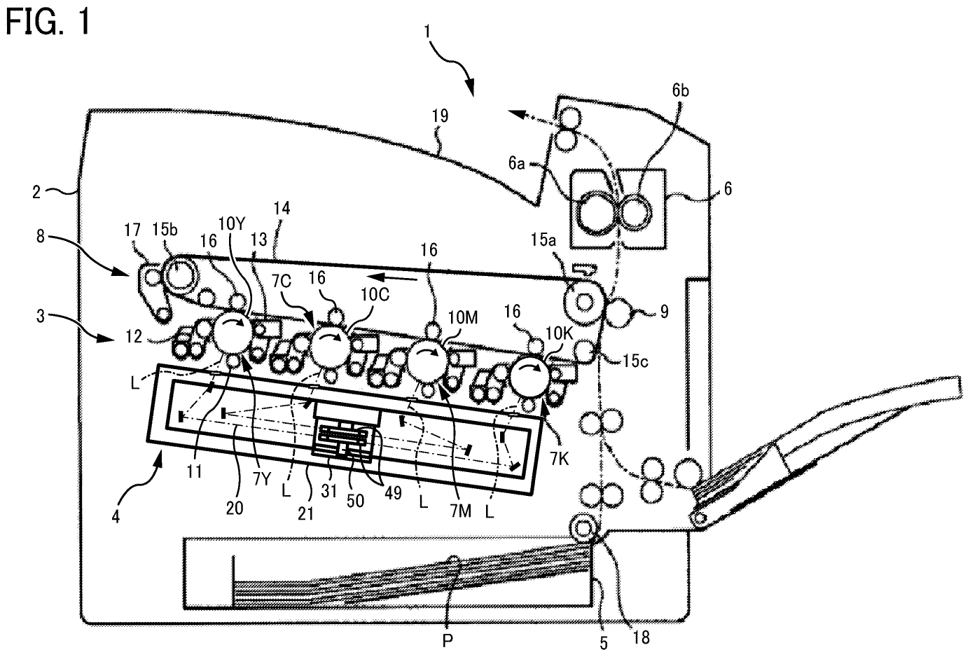

FIG. 1 is a schematic diagram illustrating a configuration of a printer 1 that serves as an image forming apparatus according to an embodiment of the present disclosure.

As illustrated in FIG. 1, the printer 1 according to the present embodiment is provided with a plurality of photoconductors 10 that serve as latent-image bearers. For example, the printer 1 according to the present embodiment serves as a so-called electrophotographic full-color image forming apparatus in which the four drum-shaped photoconductors 10Y, 10C, 10M, and 10K are arranged in tandem. Those photoconductors 10 partially serve as the four image forming devices 7Y, 7C, 7M, and 7K that handle multicolor toners. Those four image forming devices 7Y, 7C, 7M, and 7K according to the present embodiment handle multicolor toner including yellow (Y), cyan (C), magenta (M), and black (BK), respectively, to form a color image.

The printer 1 according to the present embodiment as illustrated in FIG. 1 is provided with an intermediate transfer belt 14 that serves as a surface moving unit and is supported by, for example, the three support rollers 15a, 15b, and 15c and rotates on the axis. The four image forming devices 7Y, 7C, 7M, and 7K are arranged at even intervals in the order listed from an upstream side to a downstream side of the path in the direction the intermediate transfer belt 14 moves as indicated by an arrow in FIG. 1 along a lower stretch line of the intermediate transfer belt 14.

When a full-color image is formed, as will be described later in detail, multicolored toner images are formed on the photoconductors 10Y, 10C, 10M, and 10K provided for those image forming devices 7Y, 7C, 7M, and 7K. Subsequently, as the intermediate transfer belt 14 is moved by the function of the multiple primary transfer rollers 16, the toner images of those different colors are sequentially transferred onto the intermediate transfer belt 14 by superimposing multiple images on top of one another. The multiple primary transfer rollers 16 serve as a plurality of transfer devices arranged to face the multiple photoconductors 10Y, 10C, 10M, and 10K with the intermediate transfer belt 14 interposed therebetween. More specifically, a plurality of portions on the intermediate transfer belt 14 that the multiple primary transfer rollers 16 contact are referred to as transfer positions, and transfer is performed at those transfer positions.

The four toner images that are obtained by transferring and superimposing multiple images on top of one another are collectively transferred onto a recording medium such as a sheet at the nip between the support roller 15a and the secondary transfer roller 9 all at once. Such a recording medium is a final recording medium conveyed by a conveyance unit. The recording medium such as a sheet passes through a fixing roller pair of the fixing device 6 according to the present embodiment, and then passes through a conveyance roller and is ejected onto the output tray 19 from an output roller pair. By so doing, a full-color image is formed on a sheet.

In order to comply with the one-color forming mode of only a black image, the intermediate transfer belt 14 according to the present embodiment contacts the photoconductor 10K at all times as pressed by the multiple primary transfer rollers 16. The intermediate transfer belt 14 contacts and detaches from the other photoconductors 10Y, 10C, and 10M by the function of the movable tension roller. A cleaning device 17 that removes the residual toner on the intermediate transfer belt 14 is arranged at the support roller 15b.

In FIG. 1, the image forming devices 7Y, 7C, 7M, and 7K are different from each other only in the color of toner or developer to be handled, and the mechanical structure and image forming processes are shared in common. For this reason, except for the multiple photoconductors 10Y, 10C, 10M, and 10K, the same reference signs are given to like elements, and a configuration or structure of any one of the image forming devices such as the image forming device 7Y and the processes of how images are formed thereby are described below.

For example, a charging roller 11 that serves as a charger and evenly charges the surface of the photoconductor 10Y, the positions irradiated with the light beams L, a developing device 12 that serves as a developing module to form a toner image, a primary transfer roller 16, and a plurality of cleaning devices 13 are arranged around the photoconductor 10Y of the image forming device 7Y in the clockwise rotation direction in FIG. 1.

The light beam L is emitted from the optical scanning device 4, and the optical scanning device 4 includes, for example, a semiconductor laser that serves as a light source, a coupling lens, an fθ lens, a toroidal lens, a folding mirror, a rotating polygon mirror. The light beam L of each color is emitted toward each one of the multiple photoconductors, and a writing position on the photoconductor 10Y is irradiated with the light beam L to form electrostatic latent images. The optical scanning device 4 will be described later in detail.

For example, the developing device 12 of the image forming device 7Y stores yellow developer, and visualizes a latent image with yellow images. The other image forming devices also store developers of other different colors, and visualize the electrostatic latent images with the developers of those different colors.

When an image is to be formed, the photoconductor 10Y is driven to rotate and is evenly charged by corresponding one of the multiple charging rollers 11. The photoconductor 10Y is irradiated with the light beam L including the yellow image data at the writing position, and an electrostatic latent image is formed on the photoconductor 10Y. When the electrostatic latent image passes through corresponding one of the multiple developing devices 12, the electrostatic latent image is visualized by yellow (Y) toner. A yellow (Y) toner image that is formed on the photoconductor 10Y is transferred onto the intermediate transfer belt 14 by corresponding one of the primary transfer rollers 16. Subsequently, a cyan toner image, a magenta toner image, and a black toner image are sequentially superimposed on top of one another and transferred onto the yellow (Y) toner image on the intermediate transfer belt 14 by the image forming device 7C, the image forming device 7M, and the image forming device 7K, respectively. As a result, a full-color toner image is formed on the sheet.

The sheet is sent out from a sheet feeder 5 in a timely manner using a sheet feed roller 18 and a registration roller pair 23 such that the sheet reaches the secondary transfer roller 9 at the same time as the superimposed toner image reaches the secondary transfer roller 9, and is collectively transferred at the nip between the support roller 15a and the secondary transfer roller 9 all at once as described above.

On the other hand, the residual toner is removed by the cleaning device 13 on the multiple photoconductors 10 that have completed one transfer process, and then the electricity on the multiple photoconductors 10 is removed by an electric-charge removing lamp. Then, the multiple photoconductors 10 get prepared for the next image formation. In a similar manner, the residual toner or the like on the intermediate transfer belt 14 is removed by the cleaning device 17.

The printer 1 according to the present embodiment adopts a methodology in which the toner images on the multiple photoconductors 10 are once superimposed on top of one another for the transfer on the intermediate transfer belt 14 and the superimposed toner image is transferred onto a sheet-like recording medium all at once. However, no limitation is indicated thereby, and color image forming apparatuses are also known in the art that adopt a system a recording-sheet conveyance belt that serves as a surface moving unit is arranged in place of the intermediate transfer belt 14 and a sheet is placed and conveyed by the recording-sheet conveyance belt. Such color image forming apparatuses adopt a system in which a full-color image is formed as the color toner images on multiple photoconductors are sequentially transferred onto a sheet and are superimposed on top of one another in the course of process in which the sheet is conveyed. The embodiments of the present disclosure are applicable to image forming apparatuses that adopt any one of the above systems.

There are many cases in which a plurality of resin molding components are provided for the printer 1 according to the present embodiment described above. The printer 1 according to the present embodiment involves schemes or contrivances that improve the heat resistance of a resin molded component including a housing component, the influence of the heat generated inside the printer 1 according to the present embodiment including the heat-generating components can be reduced.

### Embodiment of Scanning Device

Secondly, the optical scanning device 4 according to the present embodiment that serves as a scanning device is described below with reference to the drawings.

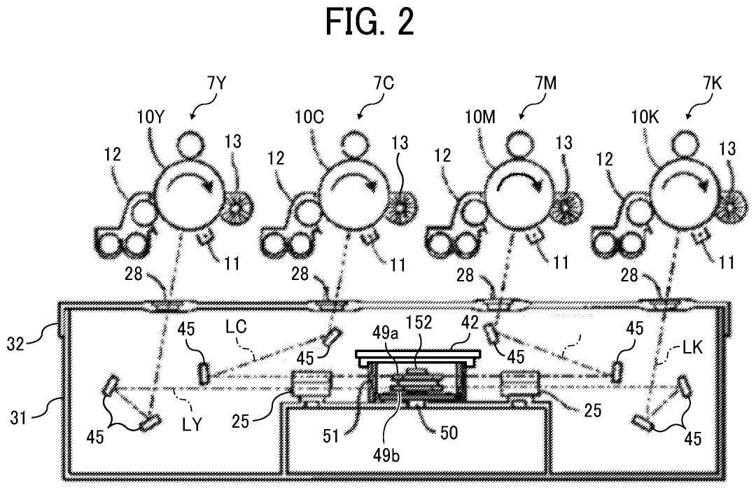

FIG. 2 is a schematic sectional view of the optical scanning device 4 according to the present embodiment, and illustrates its configuration or structure.

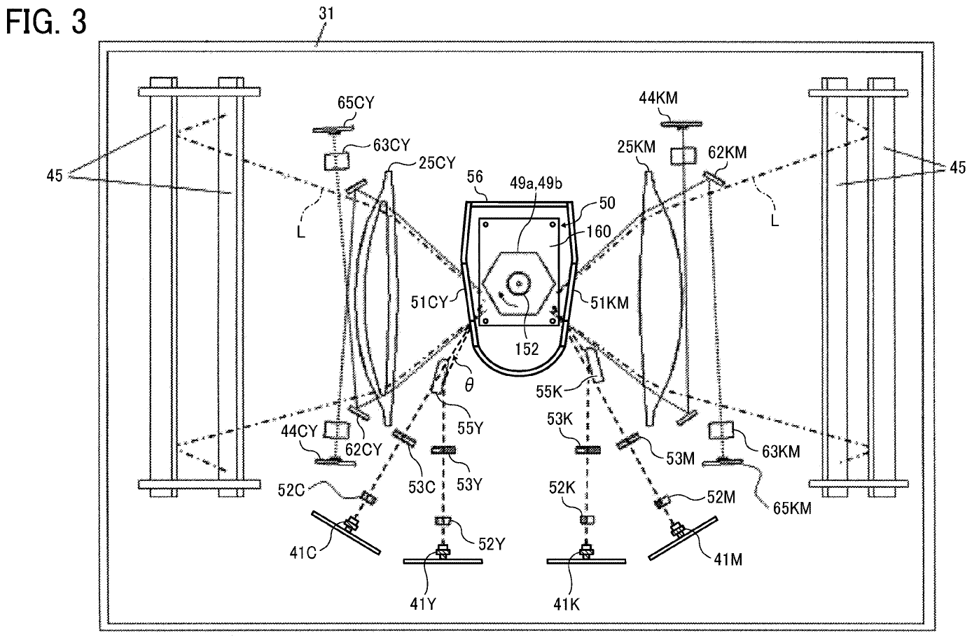

FIG. 3 is a schematic plan view and top view of the optical scanning device 4, according to the present embodiment.

As illustrated in FIG. 2 and FIG. 3, the optical scanning device 4 according to the present embodiment includes an optically-writing scanning system provided with optical components such as a polygon scanner 50, various kinds of reflection mirrors 55, and various types of lenses. The polygon scanner 50 according to the present embodiment is arranged approximately in the center of the optical scanning device 4, and arranged in the hermetically-sealed space that is surrounded by the soundproofing glass 51, a noise-abatement wall 56, and a top wall 42.

The polygon scanner 50 according to the present embodiment is provided with an upper polygon mirror 49a that has six mirror surfaces and serves as a deflective device, and a lower polygon mirror 49b that serves as a deflective device, and reflects a plurality of light beams to distribute those multiple light beams in two different directions by the plurality of the upper polygon mirror 49a and the lower polygon mirror 49b. By so doing, the polarization and scanning of the light by the polygon scanner 50 are achieved. The polygon scanner 50 according to the present embodiment is provided with, for example, a polygon motor that drives those polygon mirrors to rotate on the axis, and a control board that serves as a controller to control the polygon motor.

As illustrated in FIG. 2, the optical system for magenta (M) color and the optical system for black (K) color are arranged on the right side of the polygon scanner 50. As illustrated in FIG. 2, the optical system for yellow (Y) color and the optical system for cyan I color are arranged on the right left of the polygon scanner 50. The optical system for yellow (Y) color and the optical system for black (K) color have point symmetry with respect to the rotation axis 152 of the polygon scanner 50. The optical system for cyan I color and the optical system for cyan I color have point symmetry with respect to the rotation axis 152 of the polygon scanner 50.

As illustrated in FIG. 3, the optical scanning device 4 according to the present embodiment is provided with a plurality of semiconductor lasers 41K, 41M, 41C, and 41 Y that serve as a plurality of light sources and emit a plurality of light beams Lk, Lm, Lc, and Ly, respectively. The multiple light beams Lk, Lm, Lc, and Ly correspond to a plurality of photoconductors 10K, 10M, 10C, and 10Y, respectively.

The collimator lenses 52Y, 52M, 52C, and 52K, the multiple imaging lenses 53K, 53M, 53C, 53Y such as a plurality of cylinder lenses, and the pair of reflection mirrors 55K and 55Y are arranged on the optical path of light beams L between the semiconductor laser 41 and the polygon scanner 50. A plurality of mirrors 45 and the pair of scanning lenses 25KM and 25CY that are a pair of fθ lenses and serve as optical elements are arranged on the optical path between the polygon scanner 50 and the multiple photoconductors 10 each of which serves as a to-be-scanned object. Alternatively, a plurality of long lenses that handle lights of different colors may be arranged on the optical path between the polygon scanner 50 and the multiple photoconductors 10 each of which serves as a to-be-scanned object.

As illustrated in FIG. 3, a front-end-of-beam sensor unit 65KM for black (K) color and magenta (M) color that serves as a beam sensor and detects the front end of the light beams Lm and Lk of magenta (M) color and black (K) color is arranged on the bottom-right side.

As illustrated in FIG. 3, a rear-end-of-beam sensor unit 44KM for black (K) color and magenta (M) color that serves as a beam sensor and detects the rear end of the light beams Lm and Lk of magenta (M) color and black (K) color is arranged on the top-right side. A front-end-of beam sensor unit 65CY for cyan I color and yellow (Y) color is arranged such that the front-end-of-beam sensor unit 65KM for magenta (M) color and black (K) color has point symmetry with respect to the rotation axis 152 of the polygon scanner 50 (see top left in FIG. 3). In a similar manner to the above, a rear-end-of beam sensor unit 44CY for cyan I color and yellow (Y) color is arranged such that the rear-end-of beam sensor unit 44KM for magenta (M) color and black (K) color has point symmetry with respect to the rotation axis 152 of the polygon scanner 50 (see bottom left in FIG. 3).

After the divergent light flux is converted into collimated light flux by the collimator lenses 52Y, 52M, 52C, and 52K, the light beams Ly, Lc, Lm, and Lk that are emitted from the multiple semiconductor lasers 41K, 41M, 41C, and 41Y, respectively, pass through the multiple imaging lenses 53Y, 53M, 53C, and 53K, respectively. As passing through the multiple imaging lenses 53Y, 53M, 53C, and 53K, respectively, the light beams Ly, Lc, Lm, and Lk can be concentrated in the sub-scanning direction parallel to the direction in which the surfaces of the multiple photoconductors 10Y, 10C, 10M, and 10K move on the surfaces of the photoconductors.

The light beam Lk is reflected by the reflection mirror 55K, and passes through the soundproofing glass 51KM and is incident on the mirror surface of the lower polygon mirror 49b. Once the light beam Lk is incident on the side mirror surface of the lower polygon mirror 49b, the light beam is deflected and scanned in the direction of the main scanning line. The light beam Lk that is deflected and scanned by the lower polygon mirror 49b passes through the soundproofing glass 51KM again, and then is concentrated by the scanning lens 25KM that serves as an fθ lens. The light beam Lk of black (K) color that is concentrated by the scanning lens 25KM is reflected by the mirror 62KM, and passes through a synchronizing imaging lens 63KM and is incident on the front-end-of-beam sensor unit 65KM. Due to such a configuration, the light beam Lk is detected preparatory to scanning the photoconductor 10K. Once the front-end-of-beam sensor unit 65KM detects the light beam Lk, a synchronizing signal is output, and the timing at which the light-source signal that is converted based on the image data is output can appropriately be adjusted based on the synchronizing signal.

In a similar manner to those of the above, the light beam Lk that is emitted based on the input image data passes through, for example, the imaging lens 53K, and is scanned by the lower polygon mirror 49b and is incident on the scanning lens 25KM. As illustrated in FIG. 2, the light beam Lk that is incident on the scanning lens 25KM passes through the multiple mirrors 45 and the dustproofing glass 28, and is emitted to the photoconductor 10K.

The light beam Lm that has passed through the imaging lens 53M is directly incident on the mirror surface of upper polygon mirror 49a and is scanned. The light beam Lm that is scanned by the upper polygon mirror 49a to be used for the light of magenta (M) color is incident on the scanning lens 25KM, and is incident on the front-end-of-beam sensor unit 65KM. Due to such a configuration, a synchronizing signal is output preparatory to scanning the photoconductor 10M. the light beam Lm that is based on the image data and is emitted upon achieving synchronization passes through the upper polygon mirror 49a, the scanning lens 25KM, the multiple mirrors 45, and the dustproofing glass 28, and is emitted to the photoconductor 10M

The light beam Lc that has passed through the imaging lens 53C is directly incident on the mirror surface of upper polygon mirror 49a and is scanned. The light beam Lc that is scanned by the upper polygon mirror 49a to be used for the light of cyan I color is incident on the scanning lens 25CY, and is reflected by the mirror 62CY, and passes through a synchronizing imaging lens 63CY and is incident on the front-end-of-beam sensor unit 65CY. Due to such a configuration, a synchronizing signal is output preparatory to scanning the photoconductor 10C. The light beam Lc that is based on the image data and is emitted upon achieving synchronization passes through the imaging lens 53C, the upper polygon mirror 49a, the scanning lens 25CY, the multiple mirrors 45, and the dustproofing glass 28, and is emitted to the photoconductor 10C.

The light beam Ly that has passed through the imaging lens 53Y is reflected by the reflection mirror 55Y, and is directly incident on the mirror surface of the lower polygon mirror 49b and is scanned. The light beam Ly that is scanned by the lower polygon mirror 49b to be used for the light of yellow (Y) color passes through the scanning lens 25CY, and then is incident on the front-end-of-beam sensor unit 65CY. Due to such a configuration, a synchronizing signal is output preparatory to scanning the photoconductor 10Y. The light beam Ly that is based on the image data and is emitted upon achieving synchronization passes through the imaging lens 53Y, the lower polygon mirror 49b, the scanning lens 25CY, the multiple mirrors 45, and the dustproofing glass 28, and is emitted to the photoconductor 10Y.

As described above, the components or elements that include the semiconductor laser 41 that serves as a light source and various types of lenses such as the scanning lens 25, the collimator lens 52, and the imaging lens 53 that make up an optical system used to form an image of the light beam on each one of the multiple photoconductors 10 are held in the housing 31 in such a manner that, for example, the arrangement or orientation of each one of the components or elements is kept.

The housing 31 according to the present embodiment takes various kinds of shape depending on the installation position. For this reason, typically, the housing 31 according to the present embodiment is formed using a resin molding technique, and is a so-called resin molded product or a resin component.

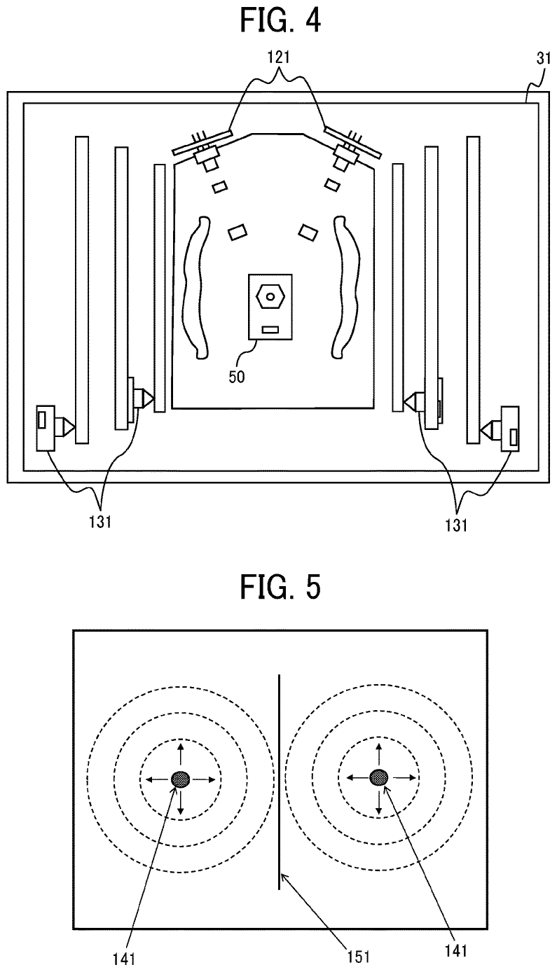

As illustrated in FIG. 4, for example, the polygon scanner 50 held in the housing 31, a stepping motor 131 that adjusts the positions of the multiple lenses, and a laser-diode (LD) control board 121 that is provided with an electronic component as a controller that controls the semiconductor laser 41 and serves as an electronic circuit board are components or elements through which certain amounts of electric current flow as power for operation. Accordingly, these components or elements are electronic components in which heat is generated due to electric current.

Accordingly, the housing 31 that serves as a resin molded product is a resin component that stores a plurality of heat-generating components, and is equivalent to a component that is likely to be affected, and is, for example, deformed, due to the heat liberated by the heat-generating components. Some portions that are not very close to any one of the heat-generating components may still be affected by the heat. In view of the above, the relative positions of heat-generating components and housing 31 and an area of the housing 31 that could be affected by the heat liberated from the heat-generating components are to be taken into consideration when the housing 31 is to be molded. In other words, the heat resistance of a heated portion of the housing 31 that could be most affected by the heat liberated from the heat-generating component or a heat source is to be kept at a sufficient degree.

In order to achieve such a configuration or structure, for example, the relative positions of a heat source and a portion of the heated portion with a relatively low degree of heat resistance are taken into consideration, or a portion with a relatively high degree of high heat resistance is arranged around the heat source.

On the other hand, there are increasing demands for the supply of the products that are produced with reduced environmental load. Accordingly, as for the housing 31 provided for the printer 1 according to the present embodiment, when a resin molded product such as a resin component is used, it is desired that a recycled material be reused in addition to a new resin material. However, such a recycled material is obtained by crushing resin molded objects that include various kinds of resin such as acrylonitrile butadiene styrene (ABS) resin, polystyrene (PS) resin, and polyoxymethylene (POM) resin into pieces and refining those crushed pieces. Accordingly, the liquidity or fluidity tends to vary especially when a molten resin is obtained from a recycled material compared with when only new materials are used.

When the liquidity or fluidity varies, defect in molding is more likely to occur in the processes of molding a resin component using injection molding. For example, defect in molding occurs due to lack of clamping pressure when the liquidity or fluidity is low. On the other hand, when the liquidity or fluidity is high, for example, biting occurs due to the residual stress at the end of the shape when the pressure is being maintained after the injection.

In order to handle such a situation, molding method such as fine foam molding may be used. In such a molding method, the resin-molding site is filled with gas such as nitrogen produced by fine foaming in the processes of resin molding using a recycled material. As a result, it is expected that the degree of liquidity be increased and the maintenance of pressure be omitted.

When the recycled material is molded using such methods as above, the degree of liquidity can be increased even with the materials having low liquidity or fluidity. The maintenance of pressure becomes unnecessary for the materials with high liquidity or fluidity, and the residual stress in the mold is reduced due to the foaming of gas. Moreover, it is less likely that biting occurs. With those effects as described above, it is expected that the defect in molding due to the variations in liquidity or fluidity of recycled material can be controlled.

For example, the housing 31 is to be molded of a material that contains recycled material, where the weight percentage of the recycled material is equal to or greater than 1, the weight percentage of the new material that is not recycled material is equal to or smaller than 99, and the weight percentage of the total of the recycled material and the new material is 100. The amount of material used in the above processes can be reduced by melting the material that contains recycled material and filling the resin-molding site with gas such as nitrogen using the fine foam molding.

FIG. 9 is a sectional view of the housing 31 that is a molding formed by fine foaming, according to the present embodiment.

As illustrated in FIG. 9, a skin layer 171 is formed on a surface layer that contacts the air. As illustrated in FIG. 9, no injected gas is present in the skin layer 171, and gas bubbles 181 are present inside the skin layer 171. Due to such a configuration, the density of one component differs between the surface layer and the inside. As the density differs between inner resin 161 and the skin layer 171 that is the surface layer, the inside of the housing 31 is filled with gas bubbles. In a similar manner to the fact that the board thickness decreases, there is some concern that the heat resistance deteriorates.

In the resin molding, a molten resin is poured into a mold from a pair of injection gates, and there is a point where the molten resin flown from one of the pair of injection gates hits the molten resin flown from the other one of the pair of injection gates and those two kinds of molten resin are cooled and solidified. Such a point where one kind of molten resin hits another kind of molten resin appears like a joint in the completed resin component, and the power of material-to-material bonding is weaker and the density gets lower at the joint than at other points. There are some cases in which such a joint-like point is referred to as a weld line, and a so-called weld line is known in the related art as a cause of a decrease in strength and appearance quality. It is also known in the art that the degree of heat resistance decreases at a weld line position where a weld line occurs.

For this reason, when a heat-generating component is arranged near the weld line position and the electronic component is heated to a high temperature, it is difficult to achieve a sufficient degree of heat resistance, and for example, deformation may occur due to the influence of heat.

In order to handle such a situation, in the housing 31 that serves as a resin component of the optical scanning device 4 according to the present embodiment, a weld line position is kept away from a prescribed range around a heated portion that may be affected by the heat at a position closest to the heat-generating component. With the use of the housing 31 that is manufactured as above, the risk of deformation and reduction in strength due to the reduction in heat resistance can be reduced in the optical scanning device 4 according to the present embodiment.

In the optical scanning device 4 according to the present embodiment, a high-heat-generating component having the highest possibility of affecting the housing 31 due to the high heat is the heat-generating component closest to the housing 31. In the present embodiment, a portion of the housing 31 that could be most affected by the heat liberated from the-high-heat-generating component is referred to as a heated portion.

As described above, the degree of influence on the housing 31, which is a resin component, caused by the high-heat-generating component varies depending on the heat resistance of a heated portion. For example, it is assumed that the LD control board 121 that is a control board that controls the operation of the semiconductor laser 41 and serves as a light-source controller is a high-heat-generating component.

It is assumed in the present embodiment that two resin components or regions of the housing 31 are arranged near the LD control board 121. It is then assumed that one of those two regions is a highly heat-resistant region in which the degree of heat resistance is relatively greater than the other regions. It is further assumed that the other one of those two regions is a low heat-resistant region in which the degree of heat resistance is relatively lower than the highly heat-resistant region.

When the LD control board 121 is heated to a high temperature in the above assumption, the risk of deformation and reduction in strength may increase in the low heat-resistant region that is a heated portion located far from the LD control board 121 that is a high-heat-generating component rather than in the highly heat-resistant region that is a heated portion located relatively close to the LD control board 121 that is a high-heat-generating component depending on the degree of temperature, in what direction the heat is conducted, or to what area the heat is conducted.

Inside the optical scanning device 4 according to the present embodiment and the printer 1 provided with the optical scanning device 4, a resin component as typified by a housing is frequently used, and high-heat-generating components such as the LD control board 121 are also frequently used. Accordingly, the relative positions of those components, the materials for those components, and the kinds of the electronic components used therein may vary widely. For this reason, it may be not practical to limit or analyze the relative positions of the high-heat-generating component and a resin component located at a position affected by the heat liberated by high-heat-generating component, and it is considered that there is a greater likelihood that the risk of deformation and reduction in strength increases when the distance between the resin component is closer to the high-heat-generating component.

FIG. 5 is a diagram illustrating a weld line position 151 caused by injection molding, according to the present embodiment.

The weld line position is a position where the molten resin injected from one of a pair of injection gates 141 hits the molten resin injected from the other one of the pair of injection gates 141 due to the flow of the molten resin ejected through the pair of injection gates 141. As illustrated in FIG. 5 by way of example, when the resin material such as molten resin is ejected from the pair of gates 141, which serve as a plurality of injection gates, and the processes of resin molding are performed, the resin material flows radially from each of the gates 141. Accordingly, the weld line position 151 is caused at a position equidistant from the pair of gates 141.

In view of the above circumstances, the optical scanning device 4 is arranged such that the position of a heated portion to be affected by the heat-generating component does not get closest to the positions equidistant from the pair of gates 141 used when the housing 31 is to be molded. By achieving such relative positions of components, the risks that may be caused by the influence of the heat on the heated portion can be reduced.

When the housing 31 molded by the resin material that has exited through one gate, the weld line position 151 is determined based on the shape of the housing 31 that has been completed. At least, the weld line position 151 is not formed near one of the pair of gates 141. For this reason, the relative positions of the weld line position 151 and a component such as a heated portion that may be affected by the heat liberated from a heat source may be determined based on the relative positions of the position closest to the heat source and the traces of the pair of gates 141, to reduce, for example, the risk of deformation and reduction in strength due to the heat. The traces of the pair of gates 141 correspond to the traces of the injection gates.

The heat-generating component according to the present embodiment indicates a component or element including a motor, a fixing heater, an electronic control board on which an electrical component or an electronic component is mounted, and a component such as a high-voltage board that may generate heat due to current or friction. Those components or elements are provided for the printer 1 or the optical scanning device 4, and the heat liberated by those components or elements tends to reach a relatively high temperature.

Currently, the circuitry of an electronic control board on which an electrical component or an electronic component is mounted is increasing in complexity, and the temperature of the heat liberated from the heat-generating component due to, for example, a defective component may increase to a high temperature. On an electrical component or an electronic component provided for an electronic control board, there are a lot of possible heat sources such as a field-effect transistor (FET), an integrated circuit (IC), a direct-current (DC) to DC converter, a regulator, and an electrostatic capacitor such as a ceramic capacitor, a porcelain capacitor, and an electrolytic capacitor.

If a short circuit occurs in the circuit from the power supply to the ground terminal, there is also a risk that a material such as glass epoxy that makes up a circuit board is heated to a high temperature. A cause of the heating to a high temperature may be, for example, an overcurrent or an overvoltage to, for example, an electrolytic capacitor due to a defective component or short circuit caused by contamination or adulteration. There may be other various kinds of causes.

The situation greatly varies depending on the type of a heat source and whether a heat-sensitive material is present around the heat source, and how the heat is conducted and whether the heat affects a heated portion vary depending on the orientation of a high-heat-generating component. It is difficult to assume those conditions in advance. In view of such circumstances, the heat affects not only the position or point of a resin component closest to a component that may be heated to a high temperature including a high-heat-generating component such as an electrolytic capacitor used for, for example, the LD control board 121 among the various kinds of heat-generating components provided for the optical scanning device 4 but also positions or points around the component in an unintentional manner.

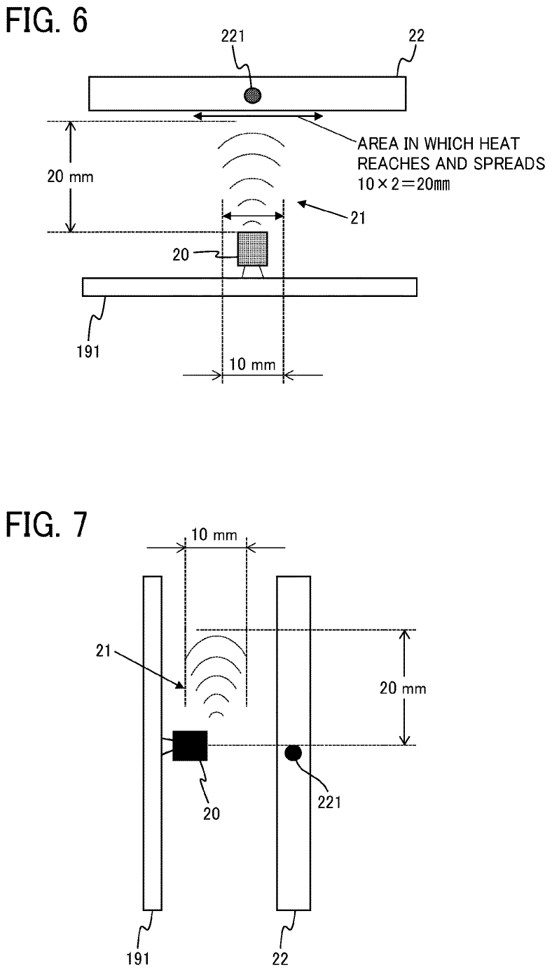

For example, as illustrated in FIG. 6, it is assumed that a heated portion that may be affected by the heat liberated from the high-heat-generating component that serves as a heat source is located above the high-heat-generating component. Moreover, it is assumed in the present embodiment that the area that could be affected by transferred heat 21 liberated from a heat-source component 20, which serves as a high-heat-generating component, is cubic space whose height and width are about 20 millimeters (mm) and 10 mm, respectively.

Under such an assumption, a heated portion that is located in the vertical direction of the high-heat-generating component is most affected in view of the direction in which the transferred heat 21 is conducted from the heat-source component 20, and a certain area around the area in the vertical direction of the high-heat-generating component is likely to be affected. For this reason, when the heated portion 22 that is easily affected by heat has to be located above the heat-source component 20, preferably, the heated portion 22 that is easily affected by heat should be kept away from an area in the vertical direction of the heat-source component 20 and a certain cubic area or space around the area in the vertical direction of the heat-source component 20.

As illustrated in FIG. 6, it is assumed in the present embodiment that the range in which the transferred heat 21 spreads along the heated portion 22 around a first portion 221 at which the transferred heat 21 is closest to the heated portion 22 is twice the width of the area of the transferred heat 21 that is 10 mm. Under such an assumption, the range in which the transferred heat 21 spreads along the heated portion 22 is 20 mm around the first portion 221. This range is referred to as a prescribed range in the following description. In view of the above, preferably, the weld line position 151 is kept away from such a prescribed range at a minimum.

As illustrated in FIG. 7, it is assumed that the heat source 191 that includes the heat-source component 20 is vertically arranged. It is assumed in the present embodiment that the heated portion 22 is arranged in the horizontal direction of the heat source 191. When a heated portion that is easily affected by heat has to be located close to the heat source 191 that includes heat-source component 20 in a lateral direction as in the present embodiment, it is desired that such a portion be kept away from a certain area above the area in the horizontal direction of the high-heat-generating component. In other words, when the heated portion 22 that is easily affected by heat has to be located close to the heat-source component 20 in a lateral direction, preferably, the heated portion 22 that is easily affected by heat should be kept away from an area in the horizontal direction of the heat-source component 20 and a certain cubic area or space around the area in the horizontal direction of the heat-source component 20.

In other words, as the transferred heat 21 is transferred in the vertical direction, the area in which the transferred heat 21 reaches the heated portion 22 and spreads around the first portion 221 at which the transferred heat 21 is closest to the heated portion 22 is equivalent to cubic space whose length of each side is equal to or shorter than 60 mm that is twice the sum of the width of the area that could be affected by the transferred heat 21 (10 millimeters (mm)) and the height of the area that could be affected by the transferred heat 21 (20 mm). In such cases, it is desired that the weld line position 151 be kept away from the above cubic space.

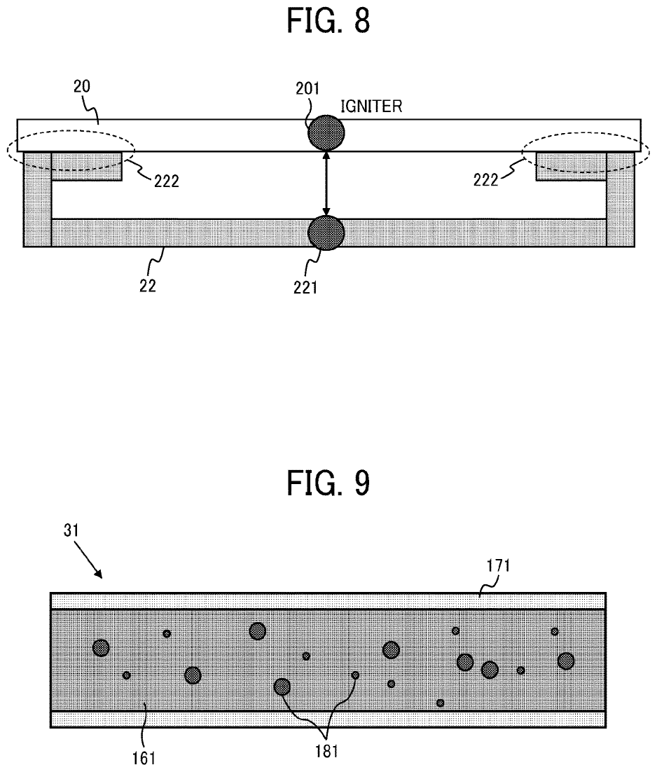

As illustrated in FIG. 8, when the heat-source component 20 contacts a portion 22 of a resin component, which serves as a heated portion or a portion that is easily affected by heat, at least at one portion, the portion 22 of the resin component closest to a high-temperature position 201 of the heat-source component 20 where the temperature is most likely to reach a high temperature is most likely affected by the heat liberated from the heat-source component 20. Not only the first portion 221 closest to the high-temperature position 201 but also a contact portion of the portion 22 of the resin component that contacts the heat-source component 20 is strongly affected by the heat. Such a contact portion of the portion 22 of the resin component that contacts the heat-source component 20 is referred to as a second portion 222 (see FIG. 8).

Accordingly, it is desired that the weld line position 151 be kept away not only from a prescribed range around the first portion 221 but also from the second portion 222.

The above-mentioned risk of exposure to high heat in the optical scanning device 4 provided for the printer 1 according to the present embodiment is described below.

FIG. 4 is a simplified plan view of the optical scanning device 4 described above with reference to FIG. 3, and illustrates the configuration or structure of its scanning optical system, according to the present embodiment.

In FIG. 4, components or elements such as a polygon scanner 50, a laser-diode (LD) control board 121, and the stepping motor 131 used to adjust the relative positions of the optical components are illustrated as the electronic components provided for the optical scanning device 4.

For example, the housing 31 according to the present embodiment may be the resin component close to or facing those electronic components. The housing 31 according to the present embodiment holds a large number of components at predetermined positions. For this reason, the housing 31 according to the present embodiment is to have a complicated shape, and tends to be composed of a resin molded product. In particular, in the case of the optical scanning device 4 used in the printer 1, the housing 31 tends to be increased in size in order to form an optical path to the multiple photoconductors 10. Accordingly, a relatively large amount of resin is used for the housing 31.

Accordingly, the multiple gates 141 that are used for resin molding tend to be multipoint gates, and a plurality of weld line positions 151 occur at a plurality of positions (see, for example, FIG. 5). When the positions of those multiple weld line positions 151 get close to the position of the heat-generating component, the risk of exposure to high heat increases. Accordingly, the risk of exposure to high heat can be reduced by keeping the areas of those heat-generating components away from the weld line position 151. In other words, the risk of exposure to high heat can be reduced by shifting the weld line position 151 away from the areas near the multiple arranged heat-generating components or facing areas.

When recycled materials are used as the resin material that is to make up the housing 31 and fine foam molding is adopted as the molding method, the heat resistance further deteriorates due to the fine foaming. Accordingly, the risk of exposure to high heat increases at the weld line position 151. In order to avoid such a situation, the weld line position 151 should be kept away from the heat source.

Among all the components or elements that make up the printer 1 according to the present embodiment, except for the optical scanning device 4, a housing component may be adopted that make up a housing that covers the exterior of the printer 1. Among all the controller components or elements used to control the operation of the printer 1, a lot of heat sources or electronic components such as a capacitor or an integrated circuit (IC) with a high risk of heat liberation are mounted on a control board used to perform electrical control or a high-voltage board used to control the electric current and voltage supplied from a power supply to a desired value. Each one of those control boards or an exterior cover such as a housing component that is arranged near the high-voltage board is one of the components that may be affected by heat liberation at a substrate or the like. Due to such a configuration, the risk of exposure to high heat can be reduced by keeping the weld line position 151 away from the area around the position closest to a heat source such as a capacitor on a control board of the exterior cover or the housing component.

In a similar manner to the exterior cover, there are many cases in which the inner cover that is arranged more internally than the exterior cover is close to the circuit board or substrate. In view of these circumstances, the risk of exposure to high heat can be reduced by taking into consideration the relative positions of the inner cover and the weld line position 151 as described above.

As described above, with the printer 1 and the optical scanning device 4 according to the present embodiment, the weld line position 151 is kept away from a position closest to a component that may liberate heat. Due to such a configuration, the risk of the heat liberated from a heat source can be reduced.

Numerous additional modifications and variations are possible in light of the above teachings. It is therefore to be understood that within the scope of the appended claims, the embodiments of the present disclosure may be practiced otherwise than as specifically described herein. For example, elements and/or features of different illustrative embodiments may be combined with each other and/or substituted for each other within the scope of this disclosure and appended claims. For example, some of the elements described in the above embodiments may be removed. Further, elements according to varying embodiments or modifications may be combined as appropriate.

Any one of the above-described operations may be performed in various other ways, for example, in an order different from the one described above. Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

By way of example, aspects of the present disclosure are given below.

### Aspect 1

A scanning device comprising:
a resin component formed by injection molding; and
an electronic component and an optical component disposed to maintain a prescribed position and posture in the resin component,
wherein at least one of the electronic component and the optical component that are used for an optically-writing scanning system serves as an electronic component that generates heat as power to be applied to operation is supplied, and
wherein at least one of the electronic component and the optical component that are used for an optically-writing scanning system serves as a heat-generating component that generates heat as power to be applied to operation is supplied, and
wherein a weld line position that occurs when the resin component is molded is kept away from a prescribed range around a heated portion of the resin component affected by the heat liberated by the electronic component.

### Aspect 2

The optical scanning device according to aspect 1,
wherein the prescribed range is cubic space around the heated portion where distance from the heated portion is equal to or shorter than 60 mm.

### Aspect 3

The optical scanning device according to aspect 1 or 2,
wherein the resin component is formed by fine foam molding and includes a component with varying densities.

### Aspect 4

The optical scanning device according to aspect 3,
wherein the resin component is made of a material including a recycled material obtained by crushing a resin molded object,
wherein weight percentage of the recycled material in the material is equal to or greater than 1,
wherein weight percentage of a new material that is not recycled material in the material is equal to or smaller than 99, and
wherein weight percentage of a total of the recycled material and the new material in the material is 100.

### Aspect 5

The optical scanning device according to any one of aspects 1 to 4,
wherein, within the prescribed range, the resin component has at least one trace of at least one injection gate through which a material is ejected when the resin component is molded.

Aspect 6

The scanning device according to any one of aspects 1 to 4,
wherein the resin component has a plurality of traces of a plurality of injection gates through which a material is ejected when the resin component is molded, and
wherein the heated portion is kept away from a position equidistant from the plurality of traces of the plurality of injection gates.

### Aspect 7

The optical scanning device according to any one of aspects 1 to 6,
wherein the heated portion includes an electronic circuit board on which the electronic component is mounted.

### Aspect 8

The optical scanning device according to any one of aspects 1 to 6,
wherein the heated portion is a capacitor included in the electronic component.

### Aspect 9

The optical scanning device according to any one of aspects 1 to 6,
wherein the heated portion includes an integrated circuit included in the electronic component.

### Aspect 10

The optical scanning device according to any one of aspects 1 to 9,
wherein the optical component includes:
a deflective device having a plurality of mirror surfaces configured to rotate and reflect a plurality of light beams emitted from a plurality of light sources to distribute the plurality of light beams in two different directions by the plurality of mirror surfaces for polarization and scanning;
an optical element configured to guide the light beam deflected and scanned by the deflective device onto a corresponding to-be-scanned object to form an image of the light beam; and
a light source configured to emit the light beam,
wherein the heated portion includes a light-source controller configured to control the light source or an operation of the light source.

### Aspect 11

An image forming apparatus comprising:
a plurality of image forming devices configured to use an optical scanning device to irradiate surfaces of a plurality of latent-image bearers with light to form a plurality of latent images on the surfaces of the plurality of latent-image bearers;
a conveyance unit configured to convey a recording medium;
a transfer device configured to transfer the latent image onto the recording medium conveyed by the conveyance unit; and
a controller configured to control operations of the plurality of image forming devices, the conveyance unit, and the transfer device; and
a housing component that covers the plurality of image forming devices, the conveyance unit, the transfer device, and the controller,
wherein the optical scanning device is the optical scanning device according to any one of aspects 1 to 10,
wherein the housing component is a resin component formed by injection molding, and
wherein the controller is an electronic component that generates heat during operation.

### Aspect 12

A scanning device comprising:
a resin component formed by injection molding; and
an electronic component and an optical component disposed to maintain a prescribed position and posture in the resin component,
wherein at least one of the electronic component and the optical component serves as an electronic component configured to generate heat as power to be applied to operation is supplied,
wherein the resin component contacts the heat-generating component at least at one contact portion of a heated portion, and
wherein at least one of the contact portion or a prescribed range around the heated portion is kept away from a weld line position that occurs when the resin component is molded.

### Aspect 13

The optical scanning device according to aspect 12,
wherein the resin component has different densities in a surface layer and an inner portion and is made of a material including a recycled material obtained by crushing a resin molded object,
wherein weight percentage of the recycled material in the material is equal to or greater than 1,
wherein weight percentage of a new material that is not recycled material in the material is equal to or smaller than 99, and
wherein weight percentage of a total of the recycled material and the new material in the material is 100.

### Aspect 14

The optical scanning device according to aspect 12 or 13,
wherein the resin component has a plurality of traces of a plurality of injection gates through which a material is ejected when the resin component is molded, in cubic space around the heated portion, where distance from the heated portion is equal to or shorter than 60 mm, within the prescribed range.

### Aspect 15

The optical scanning device according to aspect 12 or 13,
wherein the resin component has a plurality of traces of a plurality of injection gates through which a material is ejected when the resin component is molded, and
wherein the heated portion is kept away from a position equidistant from the plurality of traces of the plurality of injection gates.

### Aspect 16

The optical scanning device according to any one of aspects 12 to 15,
wherein the heated portion includes an electronic circuit board on which the electronic component is mounted.

### Aspect 17

The optical scanning device according to any one of aspects 12 to 15,
wherein the heated portion is a capacitor included in the electronic component.

### Aspect 18

The optical scanning device according to any one of aspects 12 to 15,
wherein the heated portion includes an integrated circuit included in the electronic component.

### Aspect 19

The optical scanning device according to any one of aspects 12 to 18,
wherein the optical component includes:
a deflective device having a plurality of mirror surfaces configured to rotate and reflect a plurality of light beams emitted from a plurality of light sources to distribute the plurality of light beams in two different directions by the plurality of mirror surfaces for polarization and scanning;
an optical element configured to guide the light beam deflected and scanned by the deflective device onto a corresponding to-be-scanned object to form an image of the light beam; and
a light source configured to emit the light beam,
wherein the heated portion includes a light-source controller configured to control the light source or an operation of the light source.

### Aspect 20

An optical scanning device comprising:
a resin component formed by injection molding; and
an electronic component or an optical component disposed on the resin component,
wherein a weld line position that occurs when the resin component is molded is kept away from a range in which the electronic component or the optical component are disposed.

This patent application is based on and claims priority to Japanese Patent Application No. 2023-041839, filed on Mar. 16, 2023, in the Japan Patent Office, the entire disclosure of which is hereby incorporated by reference herein.

### REFERENCE SIGNS LIST

1 Printer
4 Optical scanning device
5 Sheet feeder
6 Fixing device
7C, 7K, 7M, 7Y Image forming devices
9 Secondary transfer roller
10 Photoconductor
11 Charging roller
12 Developing device
13 Cleaning device
14 Intermediate transfer belt
15a, 15b, 15c Support rollers
17 Cleaning device
19 Output tray
20 Heat-source component
21 Transferred heat
22 Heated portion
25 Scanning lens
28 Dustproofing glass
31 Housing
41 Semiconductor laser
42 Top wall
45 Mirror
50 Polygon scanner
51 Soundproofing glass
52 Collimator lens
53 Imaging lens
55 Reflection mirror
56 Noise-abatement wall
62 CY Mirror
62 KM Mirror
63 CY Synchronizing imaging lens
63 KM Synchronizing imaging lens
65 CY Front-end-of-beam sensor unit
65 KM Front-end-of-beam sensor unit
121 LD control board
131 Stepping motor
141 Gate
151 Weld line position
161 Inner resin
171 Skin layer
181 Gas bubbles
201 High-temperature position
221 First portion
222 Second portion

1. An optical scanning device comprising:
a resin component including a weld line, the resin component formed by injection molding; and
an electronic component and an optical component disposed to maintain a prescribed position and posture in the resin component,
wherein at least one of the electronic component and the optical component that are used for an optically-writing scanning system serves as a heat-generating component that generates heat as power is supplied, and
wherein a weld line position of the weld line of the resin component that occurs when the resin component is molded is kept away from a prescribed range around a heated portion of the resin component affected by the heat from the heat generating component.

2. The optical scanning device according to claim 1, wherein:
the prescribed range is cubic space around the heated portion where distance from the heated portion is equal to or shorter than 60 mm.

3. The optical scanning device according to claim 1, wherein:
the resin component is formed by fine foam molding and includes a component with varying densities.

4. The optical scanning device according to claim 3, wherein:
the resin component includes a recycled material obtained by crushing a resin molded object,
a weight percentage of the recycled material in the resin component is equal to or greater than 1,
a weight percentage of a new material that is not recycled material in the resin component is equal to or smaller than 99, and
a weight percentage of a total of the recycled material and the new material in the material is 100.

5. The optical scanning device according to claim 1, wherein:
within the prescribed range, the resin component includes at least one trace of at least one injection gate through which a material is ejected when the resin component is molded.

6. The optical scanning device according to claim 1, wherein:
the resin component includes a plurality of traces of a plurality of injection gates through which a material is ejected when the resin component is molded, and
the heated portion is kept away from a position equidistant from the plurality of traces of the plurality of injection gates.

7. The optical scanning device according to claim 1, wherein:
the heated portion includes an electronic circuit board on which the electronic component is mounted.

8. The optical scanning device according to claim 1, wherein:
the heated portion includes a capacitor included in the electronic component.

9. The optical scanning device according to claim 1, wherein:
the heated portion includes an integrated circuit included in the electronic component.

10. The optical scanning device according to claim 1, wherein the optical component includes:
a deflector including a plurality of mirror surfaces to rotate and reflect a plurality of light beams emitted from a plurality of light sources to distribute the plurality of light beams in two different directions by the plurality of mirror surfaces for polarization and scanning;
an optical element to guide the light beam deflected and scanned by the deflector onto a corresponding to-be-scanned object to form an image of the light beam; and
a light source to emit the light beam,
wherein the heated portion includes light-source control circuitry configured to control the light source or an operation of the light source.

11. An image forming apparatus comprising:
a plurality of image forming devices to use an optical scanner to irradiate surfaces of a plurality of latent-image bearers with light to form a plurality of latent images on the surfaces of the plurality of latent-image bearers;
a conveyor to convey a recording medium;
a transferer to transfer the latent image onto the recording medium conveyed by the conveyor; and
control circuitry configured to control operations of the plurality of image forming devices, the conveyor, and the transferer; and
a housing component that covers the plurality of image forming devices, the conveyor, the transferer, and the control circuitry,
wherein the optical scanner is the optical scanning device according to claim 1,
wherein the housing component includes a resin component formed by injection molding, and
wherein the control circuitry is an electronic component that generates heat during operation.

12. An optical scanning device comprising:
a resin component including a weld line, the resin component formed by injection molding; and
an electronic component and an optical component disposed to maintain a prescribed position and posture in the resin component,
wherein:
at least one of the electronic component and the optical component serves as a heat generating component to generate heat as power is supplied,
the resin component contacts a heat-generating component at least at one contact portion of a heated portion, and
at least one of the contact portion or a prescribed range around the heated portion is kept away from a weld line position of the weld line of the resin component that occurs when the resin component is molded.

13. The optical scanning device according to claim 12, wherein:
the resin component includes different densities in a surface layer and an inner portion and includes a recycled material obtained by crushing a resin molded object,
weight percentage of the recycled material in the resin component is equal to or greater than 1,
weight percentage of a new material that is not recycled material in the resin component is equal to or smaller than 99, and
weight percentage of a total of the recycled material and the new material in the material is 100.

14. The optical scanning device according to claim 12, wherein:
the resin component includes a plurality of traces of a plurality of injection gates through which a material is ejected when the resin component is molded, in cubic space around the heated portion, where a distance from the heated portion is equal to or shorter than 60 mm, within the prescribed range.

15. The optical scanning device according to claim 12, wherein:
the resin component includes a plurality of traces of a plurality of injection gates through which a material is ejected when the resin component is molded, and
the heated portion is kept away from a position equidistant from the plurality of traces of the plurality of injection gates.

16. The optical scanning device according to claim 12, wherein:
the heated portion includes an electronic circuit board on which the electronic component is mounted.

17. The optical scanning device according to claim 12, wherein:
the heated portion is a capacitor included in the electronic component.

18. The optical scanning device according to claim 12, wherein:
the heated portion includes an integrated circuit included in the electronic component.

19. The optical scanning device according to claim 12, wherein the optical component includes:
a deflector including a plurality of mirror surfaces to rotate and reflect a plurality of light beams emitted from a plurality of light sources to distribute the plurality of light beams in two different directions by the plurality of mirror surfaces for polarization and scanning;
an optical element to guide the light beam deflected and scanned by the deflector onto a corresponding to-be-scanned object to form an image of the light beam; and
a light source to emit the light beam,
wherein the heated portion includes light-source control circuitry configured to control the light source or an operation of the light source.

20. An image forming system, comprising:
the optical scanning device according to claim 12; and
an image forming apparatus, including:
a plurality of image forming devices to use an optical scanner to irradiate surfaces of a plurality of latent-image bearers with light to form a plurality of latent images on the surfaces of the plurality of latent-image bearers;
a conveyor to convey a recording medium;
a transferer to transfer the latent image onto the recording medium conveyed by the conveyor; and
control circuitry configured to control operations of the plurality of image forming devices, the conveyor, and the transferer; and
a housing component that covers the plurality of image forming devices, the conveyor, the transferer, and the control circuitry,
wherein the housing component includes a resin component formed by injection molding, and
wherein the control circuitry is an electronic component that generates heat during operation.
